(19) United States
(12) Patent Application Publication
(10) Pub. No.: US 2023/0119108 A1
(43) Pub. Date: Apr. 20, 2023

(54) TRANSLATION MODEL WITH LEARNED POSITION AND CORRECTIVE LOSS

(71) Applicant: THE TORONTO-DOMINION BANK, TORONTO (CA)

(72) Inventors: Maksims Volkovs, Toronto (CA); Juan Felipe Perez Vallejo, TORONTO (CA); Xiao Shi Huang, TORONTO (CA)

(21) Appl. No.: 17/968,653

(22) Filed: Oct. 18, 2022

Related U.S. Application Data
(60) Provisional application No. 63/257,916, filed on Oct. 20, 2021.

(51) Int. Cl. G06N 20/00

(52) U.S. Cl. CPC G06N 20/00

(57) ABSTRACT

An autoencoder model includes an encoder portion and a decoder portion. The encoder encodes an input token sequence to an input sequence representation that is decoded by the decoder to generate an output token sequence. The autoencoder model may decode multiple output tokens in parallel, such that the decoder may be applied iteratively. The decoder may receive an output estimate from a prior iteration to predict output tokens. To improve positional representation and reduce positional errors and repetitive tokens, the autoencoder may include a trained layer for combining token embeddings with positional encodings. In addition, the model may be trained with a corrective loss based on output predictions when the model receives a masked input as the output estimate.

### CROSS-REFERENCE TO RELATED APPLICATION

This application claims the benefit of provisional U.S. Application No. 63/257,916, filed Oct. 20, 2021, the contents of which are incorporated herein by reference in its entirety.

### BACKGROUND

This disclosure relates generally to transformer models, and more particularly to non-autoregressive transformer models with sequenced input and output.

Transformer-based autoregressive (AR) machine translation models have achieved significant performance improvements, nearing human-level accuracy on some language translation tasks. An AR model is applied sequentially in generating output tokens, which can be time consuming, especially for long sequences. To accelerate inference, recent work has been exploring non-autoregressive (NAR) approaches that generate multiple output tokens in parallel. Despite significant progress, leading NAR models still lag behind their AR counterparts, and so far, approach similar performance only when when trained with distillation (i.e., trained with representations or model parameters as learned by other models, rather than solely on training data). Existing NAR approaches often struggle with effectively characterizing positional information in generating output sequences and may generate output sequences that may repeat the same output token several times in a row.

One model architecture for NAR transformer models may use anticipate the repeated application of the decoder, such that the decoder may be applied based on previously-estimated tokens (e.g., a partial translation of prior parts of the output (particularly for sequential AR approaches), or an entire estimated output sequence in order for the NAR model to account for prior estimates in the determination of current tokens. As such, one input to the decoder structure may be an “output estimate” of at least a portion of the portion of tokens and may be a sequence of the total length of expected output tokens. In this approach, the decoder may be applied iteratively, so that in the first iteration the “output estimate” may be a fully-masked sequence of tokens, and the output of the decoder is used (e.g., with re-masking of low-confidence tokens) as the “output estimate” processed for the next iteration. As such, in inference the “output estimate” may be based on a previous iteration of the decoder applied to the input sequence representation, and initially may be a fully-masked output. This may flexibly permit the model architecture to iteratively modify output token predictions, or to operate on partial data or learn to predict a token with part or all of an output sequence masked.

In training, this architecture may be trained with a known output sequence (e.g., the ground truth translation in the target language) as the “estimated output” with one or more output tokens masked to emphasize learning of the correct token for the masked position for the model. However, this training context contrasts with the model’s use during inference when, initially, no output tokens are known (i.e., they may all be masked). As such, this approach may infrequently (or never) present the model in training with examples for learning effectively based on the all-masked sequence. This may also inhibit effective learning based on the content of the input sequence representation and the all-masked encoding, such that the first pass of the decoder may contain significant errors that may (or may not) be corrected during subsequent passes. While some approaches have improved NAR model performance by using parameters of an AR model as a model for the NAR model in a distillation approach, the need for distillation suggests there are significant areas for improvement for NAR models to more effectively learn directly from the training data.

### SUMMARY

A transformer model including an encoder and decoder includes improvements to the positional representations and training of the decoder to improve non-autoregressive translation to more effectively account for errors that may be made in inference when the model begins with an all-masked output as the prior “estimated” output sequence and better account for position information.

The overall transformer model may include an encoder portion and a decoder portion. The encoder portion receives a sequence of input tokens (also termed an “input token sequence”) and generates an input sequence representation. The decoder portion receives the input sequence representation and an output estimate (e.g., a prior estimate of the output token sequence) and generates a sequence of output tokens (also termed an “output token sequence”). In typical uses, the transformer model may be used as a translation model, such that the input sequence is in one language and the output sequence is in another language, and the input and output tokens represent words, grammatical marks, punctuation, and so forth for communication in the respective languages. The transformer model may also be used for other types of sequenced input and output translation, for example, between a text string and a tokenized sequence of images or between a longer-form text (as an input) and a shorter-form version of the text in the same language (e.g., a summary or abstract for the same content) as the output. For convenience of discussion, the process of converting an input token sequence to an output token sequence may be referred to herein as “translation,” without specifically relating to conversion from one language to a different language.

To better account for positional information, the input tokens (during encoding) and/or estimated output tokens (during decoding) may be processed with positional encodings (learned or static) to generate token-position encodings that combine the respective tokens with the positional information. To do so, rather than sum the respective token with the positional encoding, the input and/or output tokens are combined with the positional encodings via a learned position combination layer that may account for the positional information more effectively than prior approaches, including those in which the positional encoding itself is learned. The learned positional combination layer thus learns the particular parameters for effectively combining the token and the positional information. The resulting token-position encodings more effectively distinguish nearby or adjacent positions and may discourage repetition of the same token in the resulting output.

In addition, the positional information in NAR language models may sometimes be ineffectively represented due to the parallelized nature of translation (i.e., that several tokens are translated at once in a given iteration, such that the translation of a particular token may not be conditioned on the current iteration’s translation of prior tokens). To maintain the effectiveness of the positional information while maintaining benefits of full self-attention, the decoder may include a masked attention layer, such that each token may attend to information from prior layers. This masked self-attention layer may be used in combination with a full self-attention layer, such that the full self-attention layer permits parallel information to transfer across the complete sequence of output tokens, while the masked attention layer encourages improved order awareness in generating output tokens, further reducing the likelihood of repetitive tokens in the output.

Finally, in some embodiments the model may be trained with an additional training loss that provides a term for correcting predictions made by the model when a fully-masked estimated output is used (e.g., as may be the case for the initial decoding iteration during inference). To do so, in one embodiment a loss may include a component based on tokens masked from a known (e.g., ground truth) output sequence and also include a component based on predictions made from a fully-masked output estimate (i.e., as would be present during inference). The predictions from the fully-masked output may be generated and then used as substitute tokens for the known output, such that the predicted token (based on the all-masked output) may replace a ground truth token in the masked training sequence, encouraging the model to learn parameters to discourage errors in the substitute token (i.e., the model’s prediction based on an all-masked input).

Using these approaches, NAR model architectures may significantly improve results and do so without requiring distillation of model parameters or representations from another previously-trained model (e.g., without learning parameters of the NAR model based on parameters of a well-performing AR model).

### BRIEF DESCRIPTION OF THE DRAWINGS

FIG. 1 shows a translation system that includes a transformer model, according to one embodiment.

FIG. 2 shows an example architecture of a transformer model, according to one embodiment.

FIG. 3 shows an example of an iterative application of the decoder, according to one embodiment.

FIG. 4 illustrates an example of generating a training loss for a transformer model, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Architecture Overview

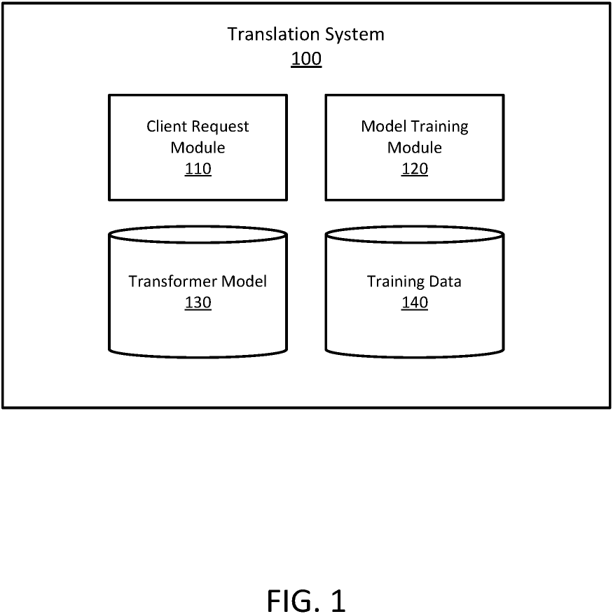

FIG. 1 shows a translation system 100 that includes a transformer model 130, according to one embodiment. The transformer model 130 is a trained computer model that learns parameters for converting a sequence of input tokens in one domain to a sequence of output tokens in another domain. As one example application, the transformer model 130 may be used to translate text from one language to another. For example, the first domain may be the German language and the second domain may be the English language. A set on input tokens for the German language may be “wir arbeiten an NLP” and the corresponding output tokens in English may be “we work on NLP.” Each of the input and output tokens may thus represent particular content from the respective domain, such as each of the individual words “we,” “work,” “on,” and “NLP.”

For language translation, the tokens are typically individual words in the respective languages, although in various domains and applications, the tokens in language translation may include other information for the respective domain, such as grammatical marks, accent marks, punctuation marks, and so forth that may be used to accurately represent information in that domain. As such, while the transformer model 130 is generally described herein as relating to language translation of text from one language to another, embodiments of the autoencoder model 130 may include other types of sequenced inputs that may be characterized with learnable tokens across different domains.

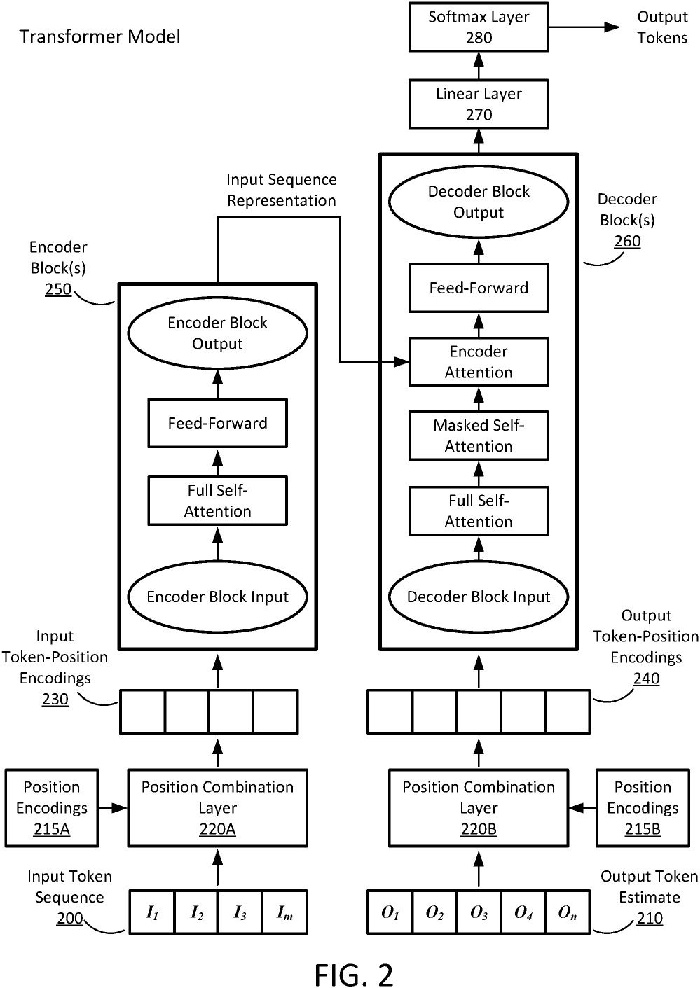

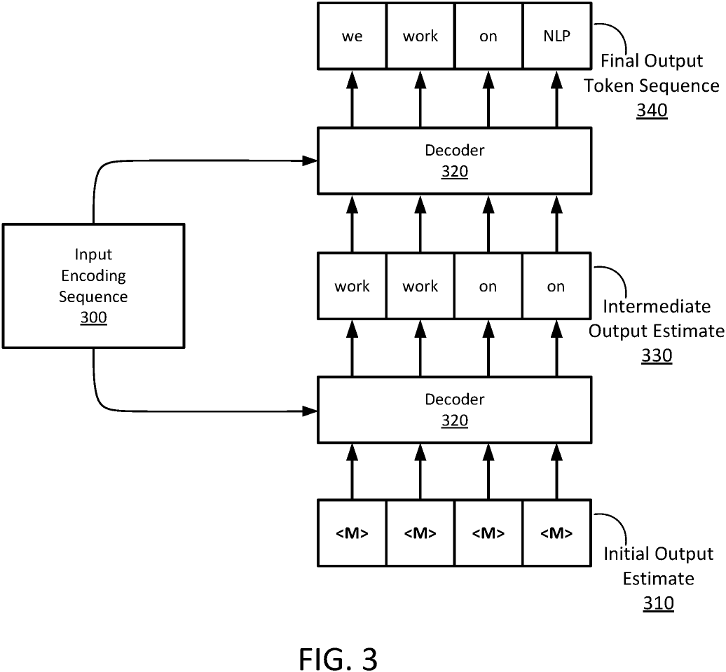

In operation, the autoencoder 130 processes the sequence of input tokens into an input sequence representation by applying an encoder to the sequence of input tokens. The input sequence representation is then processed by a decoder to generate the sequence of output tokens. The autoencoder 130 generally applies a “non-autoregressive” (NAR) approach to decoding, such that more than one output token may be predicted in parallel, rather than strictly conditioning a particular output token on the previously-predicted tokens for the output sequence. To do so, the decoder portion of the autoencoder 130 incorporates positional information in the representation of a particular output token being predicted and may include attention layers for the decoder that includes a self-attention layer and a masked self-attention layer with respect to an estimated output sequence. As discussed with respect to FIG. 3, the decoder may be iteratively applied, such that one “variable” received by the decoder to be processed for determining an output token sequence may be an output token estimate (e.g., from a previous iteration of the model or from an initialized value). The decoder attention layers may be used to improve the generation and accurate sequencing of output tokens given the parallel generation of output tokens in a given iteration. The architecture of the autoencoder model 130 is further discussed with respect to FIG. 2.

A model training module 120 may use training data 140 for training of parameters and other configuration settings of the transformer model 130. The training data 140 may include corresponding input-output pairs of a sequence of input tokens and the corresponding sequence of output tokens. The sequence of input tokens may be represented as X= {x₁, x₂, ..., xₘ}, and the output tokens as Y= {y₁, y₂, ..., yₙ}, such that the training data provides a sequence of input tokens X and the corresponding sequence of output tokens Y that should be generated by the model when the model receives input tokens X. As indicated above, the number of input and output tokens in a given pair may differ. For example, a sentence in one language may be represented in fewer words (or more precisely, tokens) than the equivalent sentence in another language.

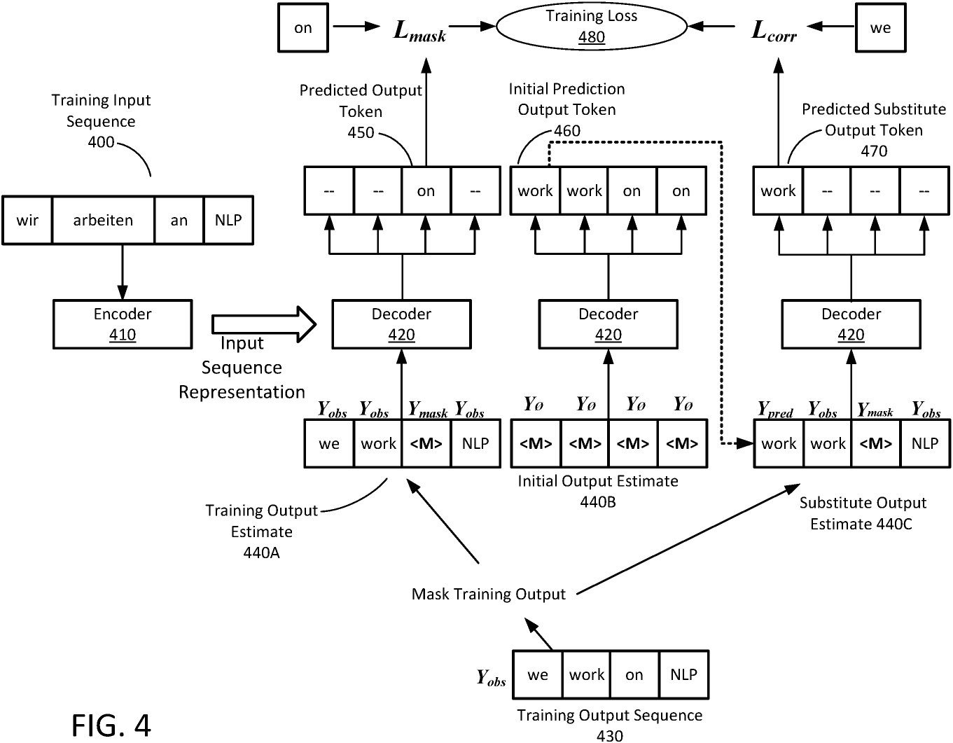

The training data 140 may thus represent a set of “correct” data, such that given a particular training input token sequence of the training data 140, a model training module 120 trains parameters of the transformer model 130 towards predicting the corresponding output token sequence of the training input token sequence. The model training module 120 may train parameters of the model based on a training loss that parameterizes the prediction error of the model and may use backpropagation, gradient descent (or its variants) and other training techniques for modifying model parameters to reduce the training loss. Further details of embodiments of the training process and a training loss are discussed with respect to FIG. 4.

Finally, the client request module 110 may apply the trained transformer model 130 to received requests and provide the output to requestors. For example, the client request module 110 may receive an input sequence of tokens (e.g., a German sentence), apply the input sequence of tokens to a transformer model 130 for German to English translation, and provide the output sequence of tokens to the requestor.

The translation system 100 is shown in relation to the components particularly related to the improved operation and training of the transformer model 130 as further discussed below. As such, the particular environment in which the translation system 100 operates may differ in various embodiments, as the translation system 100 may be operated on a server that receives requests from remote computing systems for application of requests to the transformer model 130. In other embodiments, the transformer model 130 may be trained by one computing system and deployed to another computing system for application (e.g., download by a mobile device for operation of the trained transformer model 130). As such, the translation system 100 is any suitable computing system and components as disclosed below may be separated or combined appropriately across different computing systems for operation. For example, training of the transformer model 130 may also be executed by a plurality of systems in parallel that may share information about modifying model parameters during training. Similarly, further components and features of systems that may include the translation system 100 itself and systems that may include components of the translation system 100 may vary and include more or fewer components than those explicitly discussed herein.

FIG. 2 shows an example architecture of a transformer model, according to one embodiment. In general, the transformer model architecture includes two main components: an encoder portion and a decoder portion. The encoder portion represents the portion of the transformer model that converts the input token sequence to an input sequence representation, and the decoder portion represents the portion of the transformer model that processes the input sequence representation to generate an output token sequence.

The encoder portion may begin with an input token sequence 200 in the input domain. The input token sequence 200 includes a number of input tokens of the input domain, which represent individual sequence-able components that may differ according to the particular domain. In the example above, the German language sentence “wir arbeiten an NLP” is represented as four input tokens, each corresponding to one of the four words in this sentence. Each token in the input domain (e.g., each individual word) and output domain are represented by trained multi-dimensional embeddings of an embedding dictionary. The embeddings may be pre-trained by another model that trains the embeddings to infer relational and semantic meaning from the occurrence of the tokens, e.g., based on the respective appearance of the tokens relative to one another in a sequence. The respective token embeddings may thus be determined by any suitable means. The dimensionality of the embeddings may depend on the particular embeddings used for representing the tokens and may also align with the dimensionality of the layers of the transformer model. The embeddings may thus provide a numerical representation of the tokens with respect to a multi-dimensional latent space, such that the “position” of each token typically occupies a unique “position” in the latent space. In one embodiment, the embeddings are in a 512-dimensional latent space; in other embodiments, the latent space may have a different number of dimensions. Hence, each input token of the input token sequence 200 may be converted to its respective embedding (to numerically represent the token) before input to a position combination layer 220A.

In general, the input token embedding itself may not provide positional information of the token with respect to others in the sequence, such that an additional position encoding 215A may be combined with the input embedding in the generation of the input sequence representation. As the input token sequence 200 may vary in length, the positional information may provide both absolute and relative positional information for the respective tokens. However, prior approaches for including positional encodings with the tokens may make it difficult to distinguish between individual tokens, and the representation of adj acent tokens may insufficiently differ during application. To improve the positional information incorporated with the input embeddings to represent the input sequence, the position encodings 215A are combined with the input token sequence 200 via a position combination layer 220A.

The position encodings 215A may be the same length as the embedding for an input token, and the position encodings 215A may be a trained value for a particular position or may be a result of a static function. As such, the position encoding may encode information for a particular position both relatively and with respect to the total length of the input token sequence. That is, the position encoding may be a function of the relative position and the total length of the sequence (e.g., in a 10-token sequence, the position encoding for the second token may be determined based on a function PositionEncode(2, 10)). In one embodiment, the position encoding is based on sine/cosine function that may vary values in the encoding representation with a length of the function based on the length of the input token sequence and the sampled point in the sine/cosine function based on the relative position of the input token in the sequence.

The position combination layer 220A may combine the input token sequence 200 with the position encoding 215A based on a trained computer model layer that may combine the respective values of each input token embedding and the respective position encoding. The combination of each input token embedding with the respective position encoding 215A results in a set of input token-position encodings 230, which may have one input token-position encoding for each input token. As the input token embedding and position encoding 215A in one embodiment have the same dimensionality (e.g., 512 × 2), in one embodiment the position combination layer 220A outputs an input token-position encoding 230 that has the same dimensionality as the input token embedding. In one embodiment, the position combination layer 220 is a position-wise layer between the input token embedding and the position encoding 215A. In one embodiment the input token-position encoding is formally given by a feedforward network (FFN):

$$\text{FFN:} {{x}^{′}}_{i} = \text{FFN} \left(\left[{x}_{i} , p {e}_{i}\right]\right)$$

in which Xᵢ is the input token embedding at position ᵢ, and peᵢ is the position encoding 215A for position ᵢ, which are concatenated for input to the FFN. The parameters of the position combination layer 220A may be learned during training of the encoder.

As one example of the improved incorporation of positional information, the results of the trained positional encodings as applied with the position combination layer 220 improved the relative cosine similarity of effect of the position encodings is significantly reduced, reflecting a decreased similarity of the encodings and higher discriminatory power. In examples in which the positional encoding is summed (rather than using a position combination layer), the cosine similarity of positional information is often above 0.7; using the position combination layer 220A in this example yielded no cosine similarity over 0.5. Furthermore, this also consistently reduces the number of output sequences that have repeating tokens. In particular, the most frequent one and two token repetitions are reduced by over 30% and 35% respectively.

To process the input token-position encodings 230 to the input sequence representation, one or more encoder blocks 250 may be sequentially applied to the input token-position encodings 230. Each encoder block 250 has a respective encoder block input and encoder block output, representing the inputs and outputs respectively of the encoder block 250. In one embodiment, six encoder blocks 250 are used in the encoder. In the first encoder block 250, the encoder block input is the set of input token-position encodings 230. Each encoder block output may be used as the encoder block input for the subsequent encoder block 250, with the encoder block output of the final encoder block 250 used as the input sequence representation. As such, the encoder block input and encoder block output may be a sequence of representations that may correspond to the length of the input token sequence 200. Each representation may have the same dimensionality as an input token embedding, such that the encoding blocks 250 may modify the particular values at a given position but may generally preserve the length of the input token sequence 200.

The encoder block 250 may have various layers having parameters that may be modified during training for processing the encoder block input to generate a respective encoder block output. In this example, the encoder block 250 includes a full self-attention layer and a feed-forward layer, although other embodiments may include additional or different encoder layers than those shown here. After each layer, an add-and-norm layer may be included to combine the layer input with the layer output and normalize them, which may improve model training and regularization.

The full self-attention layer provides an attention mechanism for the encoder block input (in the first layer, to the input token-position encodings 230) by projecting the encoder block input to key, value, and query matrices. The parameters for the projection may be learned during training. The respective query values for a particular position in the encoder block input may be applied to the key matrix to determine weights for combining values from the value matrix. The full self-attention layer may be implemented in various types of attention mechanisms, and may include multi-headed attention (in which multiple key, query, and value projections are calculated and combined) or a dot-product attention. The attention layer may also include a softmax layer or other normalization layer to smooth the attention based on the variable input length / length of the key/value projections based on the input token sequence 200.

As noted above, the full self-attention layer may be followed by an add-and-norm layer before the feed-forward layer. The feed-forward layer in one embodiment applies linear transformations with a linear rectification. The feed-forward layer may thus learn further parameters for a position-wise feed-forward of the values for each position in an input sequence, in one embodiment without modifying the dimensionality of the position. For example, the feed-forward network in one embodiment receives 512 values (i.e., one for each of the 512 dimensions) and applies the feed-forward layer to yield a similar output of 512 values. The resulting output from the feed-forward layer in one embodiment is followed by an add-and-norm layer, the output of which may become the encoder block output for the encoder block 250. The encoder block output of each encoder block 250 may be fed to the next encoder block 250 as the encoder block input, and for the final encoder block 250 may become the input sequence representation to be used for decoding by the decoder.

The decoder receives the input sequence representation and uses it in the generation of the sequence of output tokens. The decoder may begin with a sequence of output tokens as an output token estimate 210. The output token estimate 210 is a sequence of output tokens that may represent an “estimate” of the output tokens to be refined by application of the decoder. In one embodiment, the decoder attempts to decode the entire sequence of output tokens simultaneously.

FIG. 3 shows an example of an iterative application of the decoder, according to one embodiment. The example of FIG. 3 may show an example of the decoder applied during inference, such that initially the decoder may not have a particular prediction for the output tokens. To seed the decoder, the decoder may operate on an initial output estimate 310, in which each position in the output estimate is populated with a value for a “mask” token, designated in FIG. 3 as <M>. The mask token may also be used to designate positions for which the model is particularly encouraged to evaluate and improve translation. The decoder 320 may receive the output estimate (here, initial output estimate 310) and generate a set of output tokens as the predicted tokens for the output sequence.

To iteratively apply the model, the output may then be used as the output estimate for the next iteration. Here, the output of the first iteration of the decoder 320 is labeled an intermediate output estimate 330, which may be used as the output estimate for the next application of the decoder 320 to generate a final output token sequence 340 (in this case, two iterations of the applying the decoder 320). As such, where the input encoding sequence 300 may remain constant, the decoder 320 may revise the output estimates (predictions) over repeated iterations. As the several output tokens may be translated in parallel across a single application of the decoder 320 (e.g., as shown between the initial output estimate 310 and the intermediate output estimate 330), effectively accounting for positional information may be particularly important to improve predictions at earlier iterations, which may otherwise tend to err in sequentially producing the same token (here, illustrated in the repetition of “work” and “on” in the intermediate output estimate 330). In some embodiments, the decoder may be applied a specified number of iterations, such as five or ten, or may be adaptively applied based on the predicted confidence of tokens or the change in confidence or tokens across iterations. In some embodiments, an output estimate may have a portion of tokens between iterations (e.g., a portion having the lowest confidence) replaced with the mask token, such that the decoder 320 may emphasize revisions to the output estimate on the tokens having the mask token.

Returning to FIG. 2, to iteratively apply the decoder 320 as shown in FIG. 3, the output token estimate 210 may be the output token sequence from a prior iteration of the decoder or may be a set of initialized values, such as an all-masked sequence, for a first iteration of the decoder. As with the input tokens, the output tokens from the output token estimate 210 may be converted to respective output token embeddings and combined with position encodings 215B with a position combination layer 220B to generate output token-position encodings 240. The parameters of the position combination layer 220B and position encodings 215B may also be learned parameters during training and may differ from the parameters of the position encodings 215A and position combination layer 220A, while in other embodiments the parameters for the position combination layer 220B and position encodings 215B may be shared between the encoder and decoder. As with the encoder, the inclusion of the position combination layer 220B in the decoder may enable the decoder to more effectively represent different positions in the output sequence with higher discrimination between different positions and reduce the possibility of token repetition in the output.

As shown in FIG. 2, the output token estimate 210 may be a different length than the input token sequence 200. As several output tokens may be simultaneously generated, it may not be effective for the decoder to output a discrete “end-of-sequence” token. As such, in some embodiments, the length of the output token sequence (and correspondingly the output token estimate) may be estimated during the encoding sequence, such that the encoder includes a layer that may generate a length estimate for the output token sequence and include the length estimate with the input sequence representation. In some embodiments, the length of the output token estimate 210 may be set to the length estimate. In other embodiments, multiple output sequences may be generated for each of several output lengths, such that the output token sequence used as the final decoder output may be selected based on the output token probabilities. In one embodiment, the length estimate and/or the several output lengths may be generated based on a trained layer that uses the length of the input sequence, the tokens of the input sequence, and/or the input sequence representation.

Similar to the encoder structure, the decoder 320 may also include a set of one or more decoder blocks 260 that may be sequentially applied, such that a first decoder block 260 may receive the output token-position encodings 240 as a decoder block input, and output its decoder block output to become the decoder block input for the next decoder block 260. The decoder block output of the last decoder block 260 may then be processed to determine the output token sequence. In one embodiment, the decoder includes six decoder blocks. As with the encoder blocks 250, the decoder block input and decoder block outputs may also be sequenced representations that have an associated length that may generally correspond to the length of the output token estimate 210 (and may be, e.g., the number of tokens being translated in parallel at once). Similar to the encoder block 250, as discussed above, between each layer of the decoder block 260 may be an add-and-norm layer for combining the input of the previous layer in the decoder block 260 with the output of the current layer and normalizing them.

The layers of each decoder block 260 may include components for processing the decoder block input to determine how to process the input sequence representation for each output position. More particularly, the decoder block input may be used to generate values for an attention mechanism with respect to the input sequence representation (e.g., as discussed below with respect to the encoder attention layer).

As shown in the example of FIG. 2, in embodiments the decoder block 260 includes a full self-attention layer as well as a masked self-attention layer. The combination of both layers enables the decoder block to both attend to the entire sequence of information in the decoder block input, while also enforcing sequenced (e.g., left to right) attention. The full self-attention layer in the decoder block 260 may operate similarly to the full self-attention layer in the encoder block 250, such that the decoder block input is projected to key, value, and query values based on learned parameters, that together may form key, value, and query matrices for attending to different portions of the decoder block input. The masked self-attention layer operates similarly to the full self-attention layer, except that the masked self-attention layer may enforce an ordering to the decoder block attention of the decoder block inputs, such that a particular position in the decoder block input may only attend to (i.e., be affected by) the values from the prior positions in the sequence of decoder block inputs. In one implementation, this may be performed by setting the contribution of the subsequent tokens to zero when combining the respective values of the later tokens from the value matrix.

After the self-attention layers (here, the full self-attention and masked self-attention), the resulting information may conceptually describe information currently predicted/known about each output position in the context of the other output positions. The result of this decoder self-attention is then used to determine values for the output positions based on the input sequence representation. That is, the information from the output estimate is used to weight and select values from the input sequence representation. In one embodiment, the encoder attention layer forms key and value matrices from the input sequence representation, and a query matrix from the output attention layer(s) (here, the full self-attention and masked self-attention layers). As such, the query values (which may have the output token length) may be used to control attention for the key and value matrices representing the input sequence representation.

The result from the encoder attention layer may then be input to a feed-forward layer that may operate similarly to the feed-forward layer in the encoder as discussed above and provide a fully-connected layer position-wise for the output sequence. In the decoder shown in FIG. 2, at the output of each layer, the representation of the output sequence may continue to maintain the same dimensionality (e.g., 512). As noted above, several decoder blocks 260 may be applied in sequence with individual parameters for each block determined during training.

After the final decoder block 260, the result may be provided to a linear layer 270 that may provide a fully-connected layer for each position to output tokens for each position, after which a softmax layer 280 may convert the resulting values to probabilities of each associated output token. In one embodiment, the linear layer 270 operates as a classifier, such that each output token represents a particular class that may be output. As such, the linear layer 270 may convert the output of the decoder blocks to a likelihood of each respective output token, which is normalized via the softmax layer 280.

FIG. 4 illustrates an example of generating a training loss for a transformer model, according to one embodiment. Each training item includes a pair of input and output sequences, indicating that a training input sequence 400 should be trained to yield a training output sequence 430 after the encoding by an encoder 410 to generate the input sequence representation and decoding of the input sequence representation by a decoder 420. The encoder 410 and decoder 420 may operate as discussed above, e.g., with respect to FIG. 2. In this example, a training loss 480 for the transformer model may include two components, Lₘₐₛₖ and L_{corr}. Lₘₐₛₖ may reflect a loss when the decoder 420 receives the training input sequence 400 and a training output estimate 440A, in which the training output sequence is partially masked, such that at least some of the training output sequence is replaced with mask tokens, yielding the training output estimate 440A having some observed tokens Y_{obs} from the training output sequence, and some masked tokens Yₘₐₛₖ. The number of masked tokens Yₘₐₛₖ may vary in different embodiments and with different training approaches, and may be at least one output token and up to a percentage of the length of the training output sequence 430, such as 10%, 30%, or 50% of the training output sequence 430. The decoder 420 receives the training output estimate 440A and thus predicts the output tokens with the masked training output and the input sequence representation. The output tokens corresponding to the position that was replaced with Yₘₐₛₖ may be used as a predicted output token 450 for evaluating the loss Lₘₐₛₖ. The loss component for Lₘₐₛₖ may thereby provide effective feedback for the decoder model 420 on later decoding iterations (e.g., see FIG. 3), in which tokens of the output may have been predicted in a previous decoder iteration with relatively high confidence, but for which some tokens in the prior output may be relatively low confidence (and in some embodiments, replaced with the mask token <M> for the next iteration of the decoder). Formally, the Lₘₐₛₖ loss may be defined in one embodiment as:

$${L}_{m a s k} = - {\sum }_{y ∈ {Y}_{m a s k}} \text{log} \left(P \left(y \vert {Y}_{o b s} , X\right)\right)$$

That is, given the “observed” tokens Y_{obs} in the training output estimate 440A and the training input sequence 400 (variable X), this loss aims to improve the predicted tokens y.

However, although the Lₘₐₛₖ component may be effective for the fine-tuning later iterations in which the model has some output tokens predicted well, this loss may be ineffective for directly addressing errors that occur in the first iteration in which the decoder 420 is applied to an initial output estimate (e.g., as shown in FIG. 3) that may contain values for the output estimate before application of the decoder (e.g., in which all tokens are the mask token).

Another loss component, L_{corr} provides a loss to improve model performance more directly to these initial iterations of the model based on an initial output estimate 440B. To generate this loss, the initial output estimate 440B, including the values for the output estimate that may be used in inference in the initial application of the decoder (here, all mask tokens <M>), is applied to the decoder 420 with the input sequence representation to generate an output prediction as it may be generated in practice during inference for a first iteration. As shown in FIG. 4, these tokens may contain repeated tokens and other errors relative to the training output sequence 430. Certain of the output predictions based on the initial output estimate 440B will differ from the training output sequence 430, indicating positions in which the output token based on the initial output estimate 440B errs. For example, in FIG. 4, an initial prediction output token 460 is the token “work” rather than the training token of “we.”

To further train the model, a substitute output estimate 440C is generated, in which tokens of the training output estimate 440A (i.e., including a portion of tokens Y_{obs} from the training output sequence and masked tokens Yₘₐₛₖ) are substituted with the initial prediction output token 460. In the example of FIG. 4, the first token, previously “we” from the training output sequence 430, is substituted with the erroneous initial prediction output token 460, forming the output estimate 440C of “work work <M> NLP.” The tokens output selected from the output tokens generated from the initial output estimate 440B to be substituted in the substitute output estimate 440C may be selected in various ways. In one embodiment, a token is selected as a substitute based on a probability, e.g., so that a percentage of predicted output tokens are used as substitutes. The substitute tokens may also be selected based on a confidence score of the substitute tokens, and may also be compared with the correct tokens (e.g., the training output sequence 430) such that only substitute tokens that are incorrect are eligible for selection (e.g., that would contribute to a likely loss).

The decoder 420 may then be applied to the substitute output estimate 440C to generate an output sequence based on the substitute output estimate 440C and the input sequence representation. This provides a predicted substitute output token 470 for which the corrective loss may be determined. As the substitute output estimate 440C uses the substitute token from a prediction based on the initial output estimate 440B, the corrective loss L_{corr} may thus focus on erroneous output tokens that may appear correct when predicted from the initial output estimate 440B and when trained with a masked training output such as training output estimate 440A. In addition, because in many cases the errors of the initial output estimate 440B, such as token repetition, may occur when trained with Lₘₐₛₖ (only), the corrective loss may emphasize reducing the likelihood of the incorrect token at that position and further improve the position-awareness of the decoder 420 even when predicting multiple tokens in parallel as a non-autoregressive model.

In one embodiment, the corrective loss may be provided by:

$${L}_{c o r r} = - {\sum }_{y ∈ {Y}_{p r e d}} \text{log} \left(P \left(y \vert {Y}_{p r e d} , {Y}_{o b s} \backslash {Y}_{p r e d} , X\right)\right)$$

In which Y_{pred} are the substitute tokens in the output estimate, and Y_{obs}\Y_{pred} are the Y_{obs} (i.e., the tokens of the training output sequence) used in the training output estimate except those replaced by the substitute tokens (i.e., Y_{pred}). As such, this loss may aim to correct mistakes after in early inference steps with an initial output estimate. The total loss in training may include components for both Lₘₐₛₖ and L_{corr}. The training loss may then be backpropogated with gradients to the parameters for the decoder and encoder portions of the transformer model.

Through a dual strategy of revealing positional information and adding error correction mechanism, these approaches significantly improve NAR autoencoder performance. In particular, when trained on raw data, these approach the performances of leading AR models.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A system comprising:
a processor that executes instructions; and
a non-transitory computer-readable medium having instructions executable by the processor for:
identifying an input sequence representation of an encoded sequence of input tokens;
identifying an output estimate including a sequence of estimated output tokens;
identifying a set of positional encodings corresponding to each position in the sequence of estimated output tokens;
determining a sequence of output token-position encodings by applying a learned position combination layer to each estimated output token in the sequence of estimated output tokens with the corresponding positional encoding; and
determining a sequence of output token probabilities by applying a decoder block to the sequence of output token-position encodings and the input sequence representation.

2. The system of claim 1, wherein the learned position combination layer is a fully-connected layer.

3. The system of claim 1, wherein the decoder block includes a full self-attention layer and a masked self-attention layer applied to the sequence of output token-position encodings.

4. The system of claim 3, wherein the decoder block includes an attention layer for the input sequence representation after the masked self-attention layer.

5. The system of claim 1, wherein the decoder block estimates the sequence of output token probabilities in parallel.

6. The system of claim 1, wherein the instructions are further executable for training the parameters of the decoder block without distillation from another trained model.

7. The system of claim 1, wherein the instructions are further executable for training parameters of the decoder block with a masked loss based on a masked output estimate and a corrective loss based on a predicted output of the model when the sequence of output tokens is masked.

8. The system of claim 1, wherein the input sequence representation is generated by an encoder that includes another learned position combination layer for a sequence of input tokens and another set of positional encodings for the sequence of input tokens.

9. A method, comprising:
identifying an input sequence representation of an encoded sequence of input tokens;
identifying an output estimate including a sequence of estimated output tokens;
identifying a set of positional encodings corresponding to each position in the sequence of estimated output tokens;
determining a sequence of output token-position encodings by applying a learned position combination layer to each estimated output token in the sequence of estimated output tokens with the corresponding positional encoding; and
determining a sequence of output token probabilities by applying a decoder block to the sequence of output token-position encodings and the input sequence representation.

10. The method of claim 9, wherein the learned position combination layer is a fully-connected layer.

11. The method of claim 9, wherein the decoder block includes a full self-attention layer and a masked self-attention layer applied to the sequence of output token-position encodings.

12. The method of claim 11, wherein the decoder block includes an attention layer for the input sequence representation after the masked self-attention layer.

13. The method of claim 9, wherein the decoder block estimates the sequence of output token probabilities in parallel.

14. The method of claim 9, further comprising training the parameters of the decoder block without distillation from another trained model.

15. The method of claim 9, further comprising training parameters of the decoder block with a masked loss based on a masked output estimate and a corrective loss based on a predicted output of the model when the sequence of output tokens is masked.

16. The method of claim 9, wherein the input sequence representation is generated by an encoder that includes another learned position combination layer for a sequence of input tokens and another set of positional encodings for the sequence of input tokens.

17. A non-transitory computer-readable medium, the non-transitory computer-readable medium comprising instructions executable by a processor for:
identifying an input sequence representation of an encoded sequence of input tokens;
identifying an output estimate including a sequence of estimated output tokens;
identifying a set of positional encodings corresponding to each position in the sequence of estimated output tokens;
determining a sequence of output token-position encodings by applying a learned position combination layer to each estimated output token in the sequence of estimated output tokens with the corresponding positional encoding; and
determining a sequence of output token probabilities by applying a decoder block to the sequence of output token-position encodings and the input sequence representation.

18. The non-transitory computer-readable medium of claim 17, wherein the learned position combination layer is a fully-connected layer.

19. The non-transitory computer-readable medium of claim 17, wherein the decoder block includes a full self-attention layer and a masked self-attention layer applied to the sequence of output token-position encodings.

20. The non-transitory computer-readable medium of claim 19, wherein the decoder block includes an attention layer for the input sequence representation after the masked self-attention layer.
